(19) United States
(12) Patent Application Publication
(10) Pub. No.: US 2026/0288792 A1
(43) Pub. Date: Sep. 24, 2026

(54) ENHANCING LANGUAGE MODEL OUTPUTS VIA MULTI-TIERED PROMPTS

(71) Applicant: Optum, Inc., Minnetonka, MN (US)

(72) Inventors: Adam Taher, Oak Lawn, IL (US); Chandni Nanda, Delhi (IN); Naveen Puvvala, Eden Prairie, MN (US); Neal Robert Kelly, St Louis Park, MN (US); Jayanth M, Payyannur (IN); Rajesh Bikkanoori, Hyderabad (IN); Selene Munoz, Riverside, CA (US); Dammalapati Sai B Baba, Hyderabad (IN); Kommineni Pavitra, Hyderabad (IN)

(21) Appl. No.: 19/088,063

(22) Filed: Mar. 24, 2025

(51) Int. Cl. G06F 16/3329; G06F 40/186; G06F 40/295

(52) U.S. Cl. CPC G06F 16/33295; G06F 40/186; G06F 40/295

(57) ABSTRACT

Various embodiments of the present disclosure provide a multi-stage prompting technique that improves the functionality of a computer in various aspects. The techniques comprise receiving a generative request for a language model, wherein the generative request identifies a question-answer (QA) pair and an adherence input corresponding to the QA pair; generating a first-stage prompt that comprises the QA pair and a ruleset; inputting the first-stage prompt to the language model to receive a first-stage output from the language model, wherein the first-stage output comprises a ruleset-QA mapping between the QA pair and a rule of the ruleset; generating a second-stage prompt based on the adherence input and comprising the rule of the ruleset-QA mapping; inputting the second-stage prompt to the language model to receive a second-stage output from the language model for the generative request; and providing the second-stage output in response to the generative request.

### BACKGROUND

Traditionally, rule-based or classification models are used to evaluate adherence (e.g., to ensure information security through data access polices, or to ensure healthcare safety through healthcare guidelines) to policies or procedures through structured data matching comparisons, string-based matching comparisons, or other matching operations between input data and predefined criteria. Such models rely on exact or sufficiently exact matches between input data and predefined criteria, which may require constant updates to the predefined criteria and strict policies on the reception and use of input data and traditionally limits the application of automated adherence evaluations. Moreover, in application scenarios, such models are often limited to binary or categorical (e.g., authorized or unauthorized) outputs and fail to provide clear, context-sensitive explanations for decisions made by the models, especially when dealing with complex, multi-faceted rules. This may lead to a lack of transparency and understanding for end-users, potentially reducing trust in automated systems. Explainability, among other challenges, may be addressed using language models. However, hallucinations and other errors that are present in language models traditionally prevent their use in adherence contexts.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of example hardware and/or software components for analyzing a decisioning process in accordance with some embodiments of the present disclosure.

FIG. 5 depicts a dataflow diagram of example hardware and/or software components for generating ruleset-question-answer (QA) mappings in accordance with some embodiments of the present disclosure.

FIG. 6 depicts an operational example of a tiered prompt structure for generating a ruleset-QA mapping in accordance with some embodiments of the present disclosure.

FIG. 7 depicts an operational example of a ruleset-QA mapping in accordance with some embodiments of the present disclosure.

FIG. 8 depicts a dataflow diagram of example hardware and/or software components for generating a response to a generative request in accordance with some embodiments of the present disclosure.

FIG. 9 depicts a flowchart diagram of an example multi-stage prompting process in accordance with some embodiments of the present disclosure.

### DETAILED DESCRIPTION

Various embodiments of the present disclosure provide a multi-tiered prompting pipeline that improves computer functionality with respect to automated adherence evaluations by adapting language models to strict adherence use cases. To do so, the multi-tiered prompting pipeline of the present disclosure implements a multi-stage prompting technique that comprises a first, rule-mapping stage followed by a second, explanation stage. During the first, rule-mapping stage, a first prompt may be engineered in accordance with a first tiered structure to guide a language model through a rule-mapping process in which portions of input data (e.g., question-answer (QA) pairs) may be mapped, using semantic reasoning rather than traditionally strict string-based or structured data mapping, to portions of a complex ruleset, causing the language model to generate ruleset-QA mappings. During the second, explanation stage, the ruleset-QA mappings of the first stage may be accessed to engineer a second prompt in accordance with a second tiered structure to guide the same or different language model through an explanation process in which generative content may be created that explains an adherence decision based on the input data and the complex ruleset. By executing these stages in series, a complex adherence task may be decomposed into multiple component tasks for which specific tiered prompt structures may be applied to exert the control necessary for avoiding hallucinations and other errors that may be present in language model outputs. In doing so, the multi-tiered prompting pipeline of the present disclosure presents a unique blend of prompt chaining, task decomposition, and prompt engineering that enable the integration of language models to automated adherence systems to address the explainability and inflexibility challenges of existing automated adherence approaches.

More particularly, the multi-tiered prompting pipeline of the present disclosure implements a set of prompts in accordance with stage-specific multi-tiered prompt structures that respectively guide a language model through a multi-stage process of converting input data into explainable content, such as text summaries, images, audio, and/or the like, that is more accurate, relevant, and comprehensive than the outputs of traditional rule or classification-based approaches to automated rule adherence. A first, multi-tiered prompt structure, for example, may combine input data, a complex ruleset, and mapping instructions to focus a language model on a data mapping task between portions of the input data and the complex ruleset. The second, multi-tiered prompt structure may leverage insights from the outputs elucidated by the first prompt to focus the language model on portions of the complex ruleset for an explanation task. By leveraging these varied, tiered prompt structures to incrementally generate prompts for language models, the present disclosure provides improved processing of complex, multi-faceted rules, and natural language inputs. This, in turn, allows for the generation of concise, context-sensitive explanations that enhance transparency, accuracy, and flexibility of automated systems relative to traditional approaches.

That is, traditional rule-based systems often struggle to provide clear explanations for their decisions and require constant modifications to either complex rulesets or input data to ensure accuracy, especially when dealing with complex criteria or processing natural language inputs. The multi-tiered prompt structure of the present disclosure dissects the traditionally opaque automated process by leveraging a series of complementary language model interactions. By doing so, the multi-tiered prompting pipeline of the present disclosure may provide a more transparent and adaptable automated system.

Examples of technologically advantageous embodiments of the present disclosure comprise a distribution of language modeling functionality guided by particular prompting structures that improves language modeling technology and, as result, the functionality of a computer in various automated contexts, such as data security and other adherence use cases that rely on complex rulesets. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

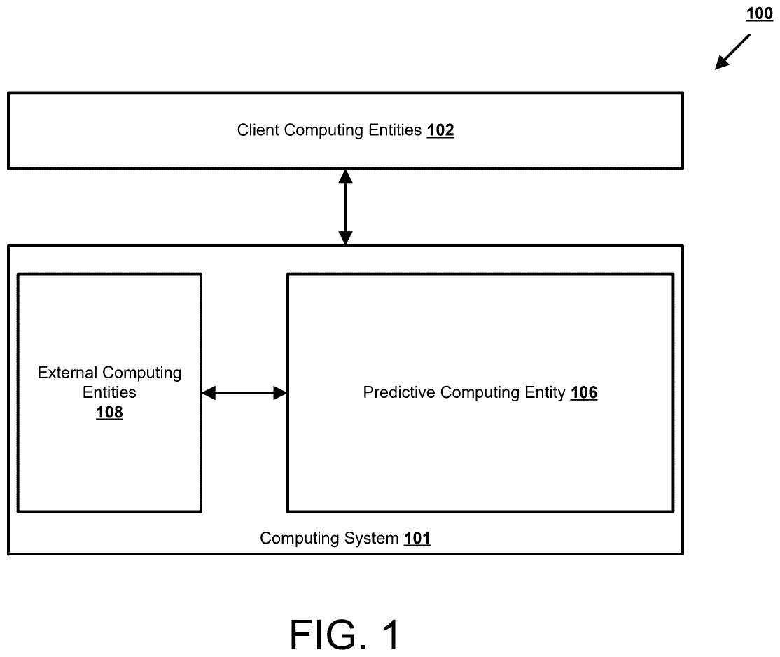

FIG. 1 depicts a block diagram of an example architecture 100 in accordance with some embodiments of the present disclosure. The architecture 100 comprises a computing system 101 configured to receive a generative request, such as a language model prompt request, and/or the like, from client computing entities 102, process the generative request, and provide a response to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive a generative request, such as a language model prompt request, and/or the like, from client computing entities 102, process the generative request, and provide a response to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., tiered prompt generation techniques, multi-stage prompting techniques, prompt engineering techniques, and/or natural language processing techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as rulesets, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some example embodiments, the predictive computing entity 106 may be configured to receive a machine learning model that is trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

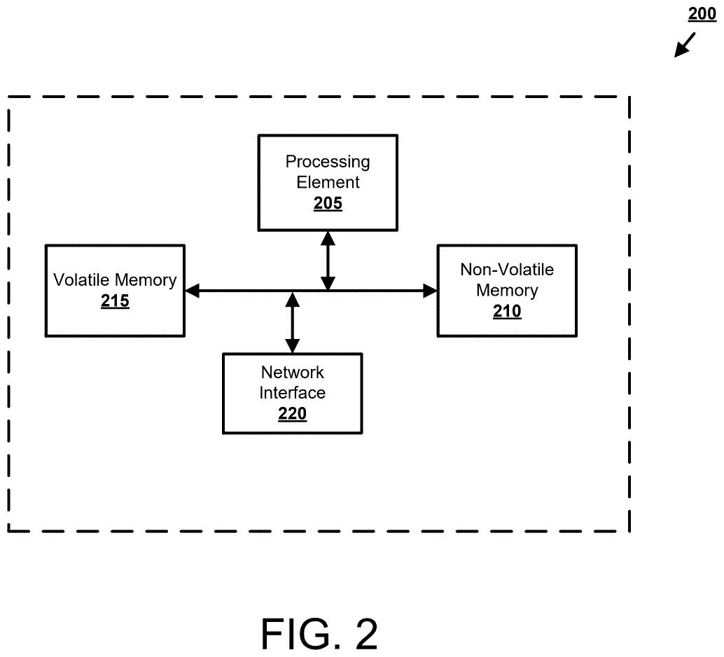

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially greater quantities of information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more components of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning tasks. By way of example, large language models (LLMs) and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entities 102, external computing entities 108), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

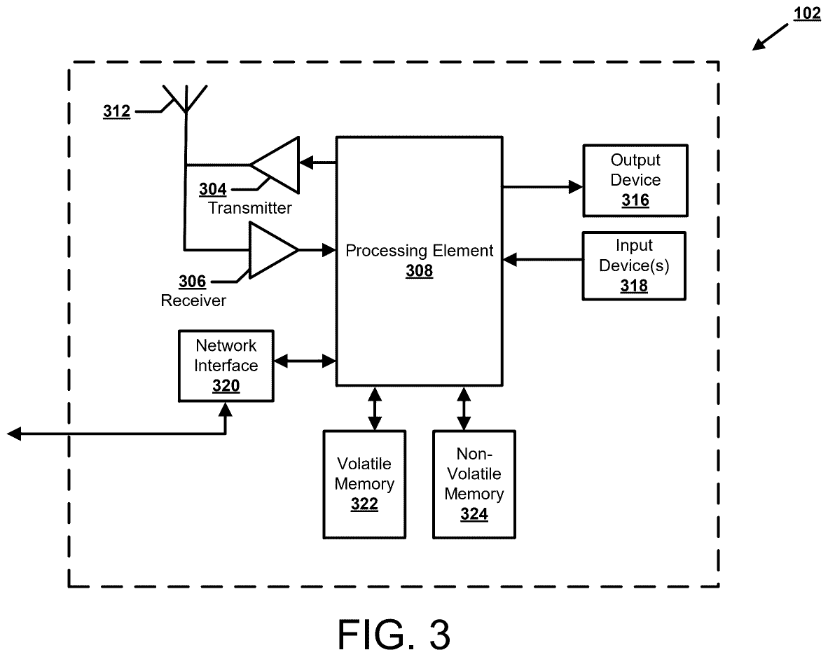

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to automated adherence systems, language modelling technology, such as the application of LLMs, among others. In particular, systems and methods are disclosed herein that implement a multi-tiered prompting pipeline to improve the accuracy of various machine learning architecture. By doing so, the multi-tiered prompting pipeline of the present disclosure enables the application of language models to strict adherence use cases, thereby improving the functionality and/or capabilities of computing systems in various technological fields, such a cyber security, healthcare, and/or the like.

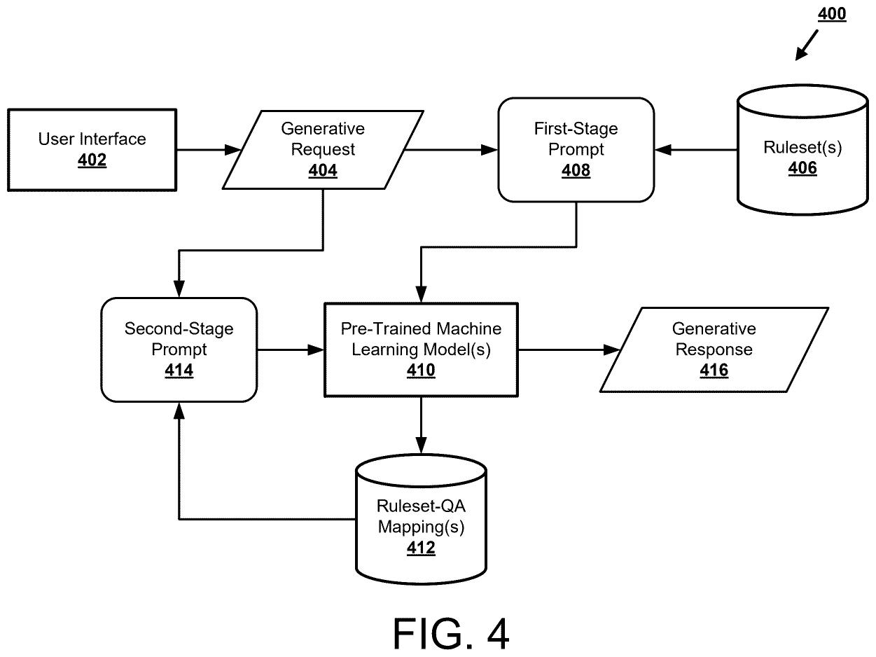

FIG. 4 depicts a dataflow diagram 400 of example hardware and/or software components for analyzing a decisioning process in accordance with some embodiments of the present disclosure. The dataflow diagram 400 illustrates a multi-tiered prompting pipeline that is configured to iteratively prompt a pre-trained machine learning model 410 to generate a generative response 416 to a generative request 404. When implemented by a computing system, such as the computing system 101, the multi-tiered prompting pipeline may improve the accuracy, flexibility, and transparency of automated responses to users.

For instance, the computing system 101 may receive a generative request 404 via a user interface 402. The user interface 402 may comprise one or more interactive fields for receiving user input data that identifies a QA pair and an adherence input corresponding to the QA pair. The generative request 404 may be used to generate a first-stage prompt 408 (e.g., in accordance with a first tiered prompt structure) that comprises the QA pair and a respectively corresponding ruleset from a memory (e.g., database of one or more rulesets 406). The first-stage prompt 408 is provided to one or more pre-trained machine learning models 410. The one or more pre-trained machine learning models 410 may comprise a language model that is configured to generate a first-stage output based on the first-stage prompt 408. The first-stage output may comprise a ruleset-QA mapping between the QA pair and a rule of the ruleset. The first-stage output may be received from the one or more pre-trained machine learning models 410 and stored to memory (e.g., a database of one or more ruleset-QA mappings 412).

The generative request 404 may be further used to generate a second-stage prompt 414 (e.g., in accordance with a second tiered prompt structure) based on the adherence input. The second-stage prompt 414 may further comprise the mapped rule of the ruleset-QA mapping, which may be accessed from memory (e.g., via the database of one or more ruleset-QA mappings 412). The second-stage prompt 414 is provided to the one or more pre-trained machine learning models 410 to generate a generative response 416. The generative response 416 may be generated based on the second-stage prompt 414 by the same language model configured to generate the first-stage output or by another language model. In this way, a series of tasks may be provided as multi-stage prompts to perform respectively corresponding multi-stage tasks in a manner that allows one or more language models to perform different levels of tasks of various complexities and focus over multiple task stages in a manner that avoids performance deficiencies, such as hallucinations, and/or the like.

In some embodiments, a generative request for a language model is received, wherein the generative request identifies a QA pair and an adherence input corresponding to the QA pair. In some embodiments, in accordance with a first tiered prompt structure, a first-stage prompt is generated that comprises the QA pair and a ruleset. In some embodiments, the first-stage prompt is inputted to the language model to receive a first-stage output from the language model, wherein the first-stage output comprises a ruleset-QA mapping between the QA pair and a rule of the ruleset. In some embodiments, in accordance with a second tiered prompt structure, a second-stage prompt is generated based on the adherence input and comprising the rule of the ruleset-QA mapping. In some embodiments, the second-stage prompt is inputted to the language model to receive a second-stage output from the language model for the generative request. In some embodiments, the second-stage output is provided in response to the generative request. For example, the QA pair comprises a question segment and an answer segment that correspond to a first interactive field within a user interface, and the second-stage output is configured to auto-populate a second interactive field within the user interface.

In some embodiments, a generative request is a request, such as an API request message, that comprises a query with one or more context and/or parameters for a desired output. For example, a generative request may comprise a structured data input that is provided to a computing system (e.g., comprising a predictive computing entity) via a user interface to initiate a process of generating specific content using a language model. In some embodiments, a generative request comprises a natural language request that is provided to a language model to generate a response. A generative request may be provided in the form of a textual prompt, image, video, audio, and/or document file.

In some embodiments, a generative request is generated in response to an input that is provided to a computing system for analysis. In some embodiments, a generative request comprises a batch job that is performed by a computing system to retrieve data stored in memory (e.g., a database) and provide the retrieved data to a language model that performs one or more natural language tasks on the retrieved data. In addition, or alternatively, a generative request may be used as an initial input that triggers a series of operations of a multi-stage processing pipeline. The series of operations, for example, may comprise database queries, natural language processing tasks, and/or machine learning model inferences configured to generate text-to-text mappings, text translations, and/or text summarizations.

In some embodiments, a generative request comprises a QA pair and/or an adherence input corresponding to the QA pair. The QA pair may comprise a subject to be analyzed and/or classified, while the adherence input may comprise a control parameter that influences how the QA pair is processed and/or classified (e.g., by providing a classification label). For example, in a healthcare context, a generative request may be used to generate a detailed explanation for a clinical decision based on a QA pair representing an answer to a clinical question and an adherence input representing whether the answer complies with the clinical question. As another example, in a computer security context, a generative request may be used to generate a detailed explanation for a resource and/or file access decision based on a QA pair representing an answer to a security policy question and an adherence input representing whether the answer complies with the security policy question.

In some embodiments, an interactive field comprises an element of a user interface, such as a drag-and-drop box or a text box, that is configured to receive images, audio, or text. For example, an interactive field may comprise segments, such as a question segment and/or an answer segment, that are configured to receive question and/or answer data, respectively, as images, text, or any other media. An interactive field may allow users to input or manipulate data within a graphical user interface, facilitating direct interaction with computing entity. For example, an interactive field may be configured to capture user input for QA pairs, adherence input, and/or other information associated with a generative request. Indeed, an interactive field may provide an intuitive and flexible interface for users to enter data that may be processed by a computing entity. For example, a drag-and-drop field might allow users to upload images or documents, while text boxes could be used for entering entity information or specific queries. Additional or alternative implementations of interactive fields may comprise voice input capabilities for hands-free data entry, or augmented reality interfaces for more intuitive interaction with imagery or 3D models.

In some embodiments, a language model comprises a predictive model, such as one or more machine learning models configured to generate an explanatory output based on a set of instructions. For instance, the language model may comprise a deep learning architecture, such as a transformer (e.g., a generative pre-trained transformer (GPT)), convolutional neural network (CNN), a long short-term memory (LSTM) network, and/or the like, that is configured to generate content (e.g., text, images, audio) in accordance with a set of instructions (e.g., a prompt). The language model, for example, may comprise multiple layers of a neural network, attention mechanisms, and/or memory components that enable the model to capture patterns and/or relationships in media content (e.g., text, images, audio). As such, a language model may be configured to comprehend a generative request, reason about the relationships between different pieces of information (e.g., between a QA pair and one or more rules of a ruleset), and generate semantically coherent media that addresses specific requirements of the generative request. In some examples, the language model may be configured to translate, in accordance with a first set of prompt instructions, non-common terms and/or jargons, generate, in accordance with a second set of prompt instructions, simplified explanations of advanced/technical concepts, and/or assist, in accordance with a third set of prompt instructions, users in understanding rules of rulesets with respect to adherence input. In this manner, the operations and/or performance of the language model may be adapted based on a set of instructions, or a “prompt,” crafted and provided to the language model.

A language model, for example, may be caused to perform tasks through targeted prompts that may represent a language in various media types, such as imagery, text, audio, and/or the like. In some embodiments, a prompt is generated for directing a language model to generate an output based on a generative request. For example, a language model may be provided with one or more prompts to understand the semantics of a QA pair, interpret an adherence input, generate a mapping between the QA pair and a rule of a ruleset, and/or generate textual explanations or summaries based on the adherence input and the mapping, as described herein.

In some embodiments, a QA pair comprises a data element comprising a question field representative of a question and an answer field representative of an answer. An answer of a QA pair may be provided via a user interface and/or retrieved from a data source in response to a prompt reflective of a question of the QA pair. A QA pair may be provided in a generative request to specify a subject for which a response or output is requested based thereof from an information retrieval and/or natural language processing system. A QA pair may comprise either a data record with two fields (e.g., a question field and an answer field) or as two related data entries or objects. For example, in a healthcare context, a question of a QA pair may be “what is the patient's current medication?” and a corresponding answer of the QA pair may comprise “Lisinopril 10 mg daily.” As another example, in a computer security context, a question of a QA pair may be “what is the user's access privileges?” and a corresponding answer of the QA pair may comprise “access tier 1.” In any domain, a QA pair may be mapped to one or more rules of a ruleset such that the mapping may be used as a basis for generating a response and/or output of a generative request. For example, a QA pair may be analyzed to (i) extract relevant information (e.g., a question and a respectively corresponding answer), (ii) identify relationships with respect to one or more rules of a ruleset, and/or (iii) make inferences that inform subsequent processing steps.

In some embodiments, an adherence input comprises a data entry that is representative of an indication of eligibility or ineligibility of a policy or procedure based on one or more rules of a ruleset. For example, an answer that is provided in response to a prompt reflective of a question of a QA pair may be compared with a criterion, and as such, an adherence input may be provided via a user interface for the answer based on the comparison. Adherence inputs may be provided in conjunction with QA pairs in a generative request to provide context for a language model's output generation. For example, an adherence input may be provided along with a QA pair in a generative request to indicate that the QA pair is associated with an eligibility or ineligibility of one or more rules of a ruleset. As such, adherence inputs may be used to bridge a gap between raw data (e.g., QA pairs) and rules of a ruleset. In some embodiments, if an adherence input indicates that a QA pair does not satisfy a rule of a ruleset, an explanation output is generated to provide a reason why the rule was not satisfied and/or what steps may be taken to satisfy the rule.

In some embodiments, an adherence input comprises a data variable (e.g., an unmet indicator) that is assigned to a QA pair to provide a signal of whether the QA pair satisfies a particular set of criteria or requirements within a defined policy framework. An adherence input may comprise a Boolean value, an enumerated type, or a data structure suitable for representing a status code (e.g., “satisfied,” “not satisfied,” or “partially satisfied”).

In some embodiments, a tiered prompt structure comprises a framework for a prompt associated with a tier of a plurality of prompt tiers. A tiered prompt structure may comprise a prompt engineering mechanism for systematically constructing prompts that direct a language model to perform a series of tier-specific tasks and/or generate a series of tier-specific outputs at specific prompt tiers of a plurality of prompt tiers. Accordingly, tier-specific information may also be provided to a language model at a prompt tier via a tiered prompt structure. In some embodiments, a tiered prompt structure for a prompt tier is provided by a prompt template. A prompt template may comprise predefined prompt instructions that are arranged in accordance with a tiered prompt structure criterion that is specific to a prompt tier.

A tiered prompt structure may be used to systematically construct prompts for a language model at different stages of processing. For example, a first-stage prompt may comprise a first-tiered prompt structure that is associated with generating a first-stage output based on a QA pair and a ruleset, a second-stage prompt may comprise a second-tiered prompt structure that is associated with generating a second-stage output based on the first-stage output, and/or the like. As such, a tiered prompt structure may allow a language model to be provided with different levels of tasks of various complexities and focus over multiple task stages in a manner that guides the processing of the language model to avoid performance deficiencies, such as hallucinations, and/or the like, that traditionally hinder the performance of language models. In this manner, a tiered prompt structure may improve the consistency and quality of outputs generated by a language model and prevent hallucinations that may be caused by errors propagated from a series of complex tasks.

In some embodiments, a prompt comprises one or more instructions that are provided to a language model for generating an output. That is, a prompt may be used to communicate with a language model. For example, a prompt may comprise natural language in the form of a string, a structured text object, imagery, audio, and/or the like, that is interpretable by a language model to perform specific tasks and/or generate outputs. In some embodiments, a prompt comprises a generative request, a relevant ruleset, and/or specific instructions on how to process and/or respond to the generative request.

A prompt may be generated by using natural language processing techniques to provide clarity and effectiveness. A prompt may also incorporate various elements, such as context setting, explicit instructions, examples, and/or input data. As such, prompts may be generated to guide a language model's behavior such that the language model may generate outputs that are relevant, accurate, and/or aligned with specific output requirements (e.g., of a prompt tier). In some embodiments, a prompt is generated based on a prompt template that is associated with a tiered prompt structure. In some embodiments, a prompt is generated using few-shot or zero-shot learning techniques, where examples or task descriptions are incorporated into the prompt to guide a language model's behavior.

In some embodiments, a prompt template comprises a set of prompt instructions comprising a preset format for generating a prompt. For example, a prompt template may serve as a structured blueprint for generating standardized prompts for guiding a language model's behavior and/or output generation in a consistent manner. Prompt templates may be implemented using string formatting techniques, template engines, or natural language generation systems. A prompt template may comprise elements, such as directives, examples, roles, output formatting, and/or context. A prompt template may be stored in a configuration file, database, or content management system, allowing for easy modification and/or version control.

Prompt templates may be used to ensure consistency and/or efficiency in generating prompts for a language model. According to various embodiments of the present disclosure, prompts are provided to a language model to generate different outputs at various stages. As such, a prompt template may be associated with a specific language model output-generating stage. A prompt template may be configured with a set of predefined instructions for a specific language model output-generating stage.

In some embodiments, a ruleset comprises one or more rules that are associated with a policy or procedure. For example, a ruleset may comprise rules that are associated with structured guidelines or criteria that define conditions and/or requirements for making decisions or taking actions within a specific domain or process. A ruleset may be implemented using various data structures and/or algorithms, such as decision trees, rule engines, and/or expert systems. For example, a ruleset may comprise one or more rule data objects that represent one or more logic and/or conditions that respectively correspond to one or more rules. A ruleset may also be stored in a database or configuration file to facilitate management and updates of the ruleset.

A ruleset may be used to evaluate adherence to a policy or procedure and generate explanatory and/or summative assessments. In some embodiments, a ruleset provides a framework against which QA pairs and other inputs are assessed. For example, in a healthcare context, a ruleset may define a criterion for a clinical decision based on factors, such as patient age, medical history, previous treatments, and/or the like. As another example, in a computer security context, a ruleset may define authorization criteria for enabling access to a computing system based on factors, such as a user's identity, recent activity, access privileges, and/or the like. As such, a ruleset may provide a structured and consistent basis for decision-making. When combined with a language model, a ruleset may be used to generate explanations for decisions (e.g., an adherence input), thereby translating technical criteria into more understandable language. In this manner, a ruleset may be used to counteract performance deficiencies with language models, such as hallucination tendency, and/or the like.

In some embodiments, a rule comprises a stipulation or requirement for satisfying a condition of a policy or procedure. For example, a rule may comprise an individual criterion, factor, and/or guideline (e.g., of a ruleset) that is considered in a decision-making process. A rule may comprise a logical statement and/or a conditional expression, such as an if-then statement, a Boolean function, and/or an instruction that associates a condition and one or more actions and/or outcomes. As disclosed herewith, a rule may be used in decision-making processes. That is, a rule in a ruleset may respectively correspond to a specific aspect of a policy or procedure that is verified and/or checked for satisfaction. For example, in a healthcare context, a rule may comprise a condition “if the patient is under 18 years old, then parental consent is required for the procedure.” As another example, in a computer security context, a rule may comprise a condition “if a tier 1 resource is requested, then tier 1 access privilege is required.”

Accordingly, a rule may provide a basis for generating explanations and/or justifications for decisions. In some embodiments, when a rule of a policy or procedure is not satisfied, a language model may be configured (e.g., via one or more prompts) to use the rule's definition and context to generate summarization text that articulates why the rule was not met. Thus, a rule may provide a basis for a language model to generate more understandable and/or informative responses, especially in complex domains, such as in healthcare where decisions may be explained to patients or healthcare providers.

In some embodiments, a ruleset-QA mapping comprises an association between rules of a ruleset to QA pairs. A ruleset-QA mapping may provide a structured relationship between a QA pair and a rule such that the rule may be identified, referenced, and/or retrieved in response to a query that matches the QA pair. A ruleset-QA mapping may be implemented using various data structures, such as hash tables, graphs, or relational database schemas. A ruleset-QA mapping may be generated (e.g., by a language model) to define relationships between rules and case-specific information. As such, a ruleset-QA mapping may be used to identify which rules are relevant to a given set of QA pairs, and conversely, which questions are evaluated for specific rules. For example, a rule about medication dosage may be mapped to question(s) about a patient's age, weight, and/or current prescriptions.

In some embodiments, a language model is configured (e.g., by providing a prompt) to generate, based on a ruleset-QA mapping, explanations of satisfied and/or unsatisfied rules of a policy or procedure with respect to a QA pair (e.g., that is associated with a generative request). In some embodiments, a language model is configured (e.g., by providing a prompt) to generate, based on a ruleset-QA mapping, interactive decision trees or flowcharts, that provide guidance to an end-user through a policy or procedure evaluation process in a more intuitive manner. In some embodiments, a language model is configured (e.g., by providing a prompt) to identify and/or ask additional questions based on a ruleset-QA mapping to further evaluate rules that may be potentially relevant to a QA pair (e.g., that is associated with a generative request).

According to various embodiments of the present disclosure, a ruleset-QA mapping comprises an output that is generated by a language model during an intermediate step in generating a response to a generative request. For example, a ruleset-QA mapping may be generated as a first-stage output by a language model, where the ruleset-QA mapping may be used by the language model to further generate a second-stage output. Accordingly, by generating a ruleset-QA mapping as an intermediary output of a dedicated task, hallucinations caused by errors propagated from a series of convoluted intermediate tasks may be prevented, thereby improving the accuracy and/or performance of a language model.

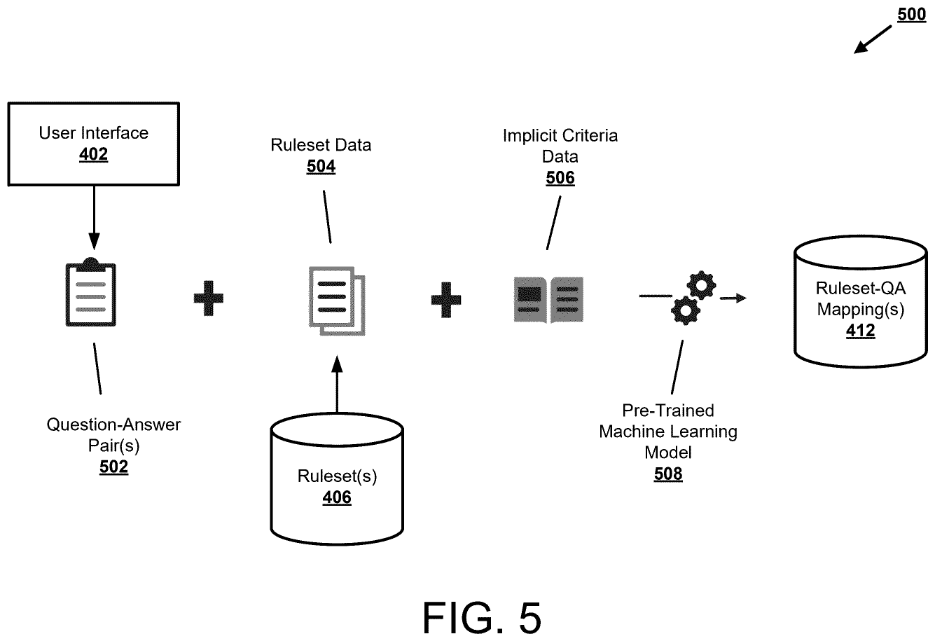

FIG. 5 depicts a dataflow diagram 500 of example hardware and/or software components for generating ruleset-question-answer (QA) mappings in accordance with some embodiments of the present disclosure. As shown in the operational example 500, QA pair 502, ruleset data 504, and implicit criteria data 506 are provided as inputs (e.g., via first-stage prompt 408) to a pre-trained machine learning model 508 (e.g., of the one or more pre-trained machine learning models 410). The QA pair 502 is received via the user interface 402, for example, as part of and/or in the form of a generative request. The QA pair 502 may pertain to a ruleset data 504, which is retrieved from the database of one or more rulesets 406. The implicit criteria data 506 may comprise contextual data (e.g., comprising a set of contextual attributes) that is used to enhance and/or tailor output generated by the pre-trained machine learning model 508 to a specific entity.

As disclosed herewith, a first-stage prompt may be generated based on the QA pair 502, ruleset data 504, and implicit criteria data 506. The first-stage prompt may be generated in accordance with a first tiered prompt structure that is specific to a ruleset-QA mapping task to be performed by the pre-trained machine learning model 508. The ruleset-QA mapping task may comprise a task (e.g., first-stage) of a plurality of tasks. Accordingly, the first-stage prompt may be provided to the pre-trained machine learning model 508 such that the ruleset-QA mapping task may be performed by the pre-trained machine learning model 508 to generate a ruleset-QA mapping between the QA pair 502 and one or more rules of the ruleset data 504. An output (e.g., a first-stage output) comprising the ruleset-QA mapping may be received from the pre-trained machine learning model 508 and stored in memory (e.g., in a database of one or more ruleset-QA mappings 412) for subsequent retrieval (e.g., in a second-stage task and/or for generating a second-stage prompt). In this way, the pre-trained machine learning model 508 may be provided with a specific task focus that is part of a variety of tasks in a manner that guides the processing of the pre-trained machine learning model 508 to avoid performance deficiencies, such as hallucinations, and/or the like, that traditionally hinder the performance of machine learning models.

In some embodiments, a first-stage prompt comprises a ruleset, a first set of prompt instructions, a QA pair, and a set of contextual attributes that are arranged in accordance with a first tiered prompt structure criterion. In some embodiments, a generative request comprises an authorization identifier, a set of QA pairs, a set of adherence inputs respectively corresponding to the set of QA pairs, and the set of contextual attributes. In some embodiments, generating the first-stage prompt comprises (i) receiving the ruleset and a first-stage prompt template based on the authorization identifier, wherein the first-stage prompt template comprises the first set of prompt instructions and (ii) modifying the first-stage prompt template with the ruleset, the set of QA pairs, and the set of contextual attributes to generate the first-stage prompt. In some embodiments, (i) the generative request corresponds to a target entity associated with an entity profile and (ii) the set of contextual attributes comprises an attribute from the entity profile.

In some embodiments, a contextual attribute comprises context-specific data that is associated with an entity of a generative request. For example, contextual attributes may provide additional information or parameters for tailoring output generated by a language model to specific circumstances, properties, or inherencies of an entity that are not explicitly provided in a generative request. Contextual attributes may enrich a generative request with relevant background information that may influence output generation (e.g., by a language model) in response to the generative request). For example, in a healthcare scenario, contextual attributes may comprise a patient's age, gender, medical history, or insurance plan details. As another example, in a computer security scenario, contextual attributes may comprise a user's identity, recent activity, access privileges, device configurations, and/or the like.

Accordingly, contextual attributes may be used to generate more personalized and/or accurate responses that take into account specific circumstances. Thus, contextual attributes may be provided (e.g., in a prompt) to a language model such that the language model may consider a specific set of factors in generating outputs that are more relevant, accurate, and/or sensitive to individual entity circumstances. In some embodiments, contextual attributes are used for dynamic prompt adjustment, where a structure or content of a prompt is modified based on the contextual attributes.

In some embodiments, an entity comprises a source, focus, subject, or originator of a QA pair in a generative request. For example, an entity may represent an element or actor to which information in a QA pair pertains. Accordingly, entities may represent focal points for contextualizing QA pairs. Thus, a response that is relevant to a specific entity may be generated for a generative request. An entity may be represented as an object or data structure that encapsulates various attributes and/or relationships. Additionally, and/or alternatively, an entity may be represented as a class with properties and/or methods that define its characteristics and behaviors. Additionally, and/or alternatively, an entity may be represented by a table, record, or document that is stored in a database.

In some embodiments, an entity profile comprises a record or aggregated set of information that is associated with an entity. For example, an entity profile may comprise a collection of data points, attributes, and/or historical information that provide a detailed characterization of a specific entity. An entity profile may be retrieved to provide contextual information (e.g., to a language model) for generating responses to generative requests. By referencing entity profiles, a language model may generate responses that are tailored to specific circumstances and history of an entity in question (e.g., with respect to a generative request), thereby leading to more accurate, relevant, and/or personalized output (e.g., explanations or recommendations) that is generated by the language model.

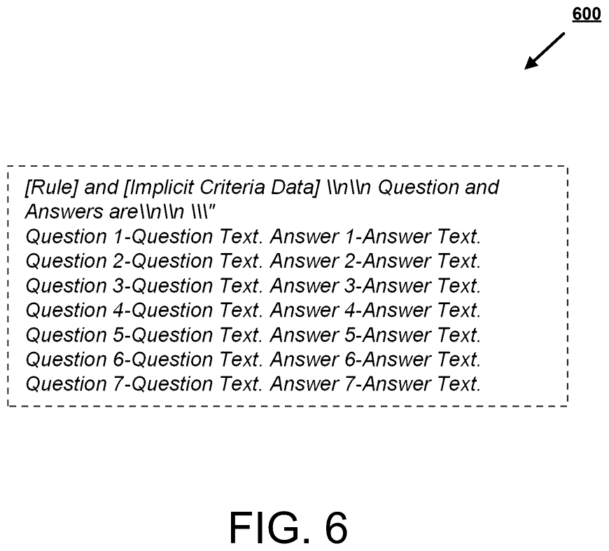

FIG. 6 depicts an operational example of a tiered prompt structure 600 for generating a ruleset-QA mapping in accordance with some embodiments of the present disclosure. As shown in FIG. 6, the tiered prompt structure 600 comprises a rule that is associated with a set of QA pairs, implicit criteria data, and the set of QA pairs. In this way, a tiered prompt structure may provide a structured blueprint for generating standardized prompts for guiding a machine learning model's (e.g., a language model) behavior and/or output generation in a consistent manner.

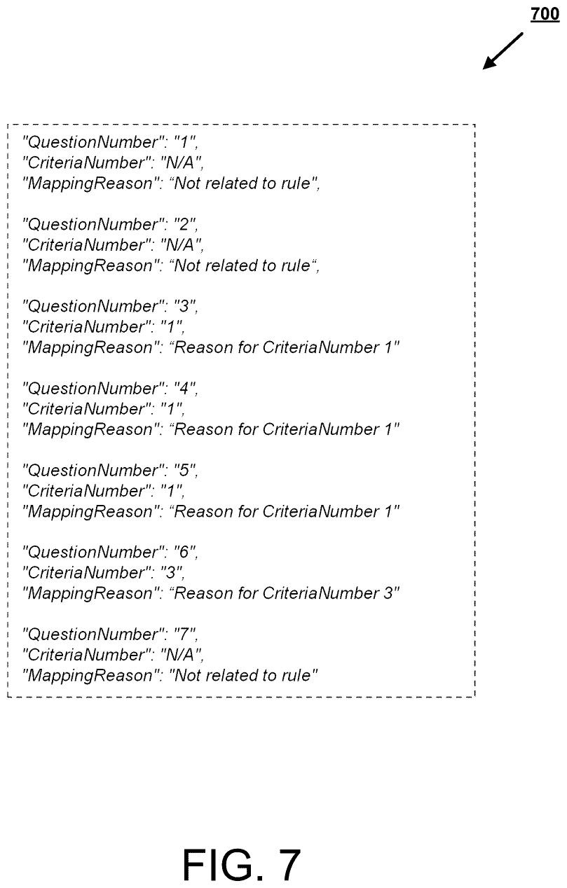

FIG. 7 depicts an operational example of a ruleset-QA mapping 700 in accordance with some embodiments of the present disclosure. As shown in FIG. 6, the ruleset-QA mapping 700 comprises a set of mappings that comprise “QuestionNumber,” “CriteriaNumber,” and “MappingReason” fields for a plurality of questions from a QA pair. The “QuestionNumber” field may comprise a reference to a question from the QA pair. The “CriteriaNumber” field may comprise a reference to a criteria number of a ruleset or rule of the ruleset. The “MappingReason” field may be representative of a reason for generating a mapping of a specific “QuestionNumber” to a “CriteriaNumber.” Accordingly, by generating a ruleset-QA mapping as an intermediary output of a dedicated task, hallucinations caused by errors propagated from a series of convoluted intermediate tasks may be prevented, thereby improving the accuracy and/or performance of a machine learning model, such as language model.

In some embodiments, a ruleset-QA mapping comprises a structured data object that identifies a rule, a question segment of the QA pair, and an explanatory output that is based on an answer segment of the QA pair and the rule.

In some embodiments, an explanatory output comprises text representative of a reason for generating a mapping between a QA pair and a rule of a ruleset by a language model. That is, an explanatory output may provide a human-readable and interpretable justification or rationale for why a particular association was made by a language model between an answer provided in a QA pair and a specific rule. An explanatory output may be generated using various natural language generation (NLG) techniques, such as abstract summarization, key point extraction, or causal reasoning.

Explanatory outputs may provide transparency and understanding in a decision-making process by bridging a gap between technical evaluations and a desire for clear, comprehensible explanations. For example, when a transaction request is denied, a language model may generate explanatory output that details which specific policy rules were applied, how transaction information (from a QA pair) are related to the policy rules, and why the decision was made. Explanatory outputs may also be used to build trust, facilitate informed decision-making, and/or allow users to understand a reasoning behind automated decisions, which may be particularly important in sensitive domains, such as healthcare, banking, cybersecurity, etc.

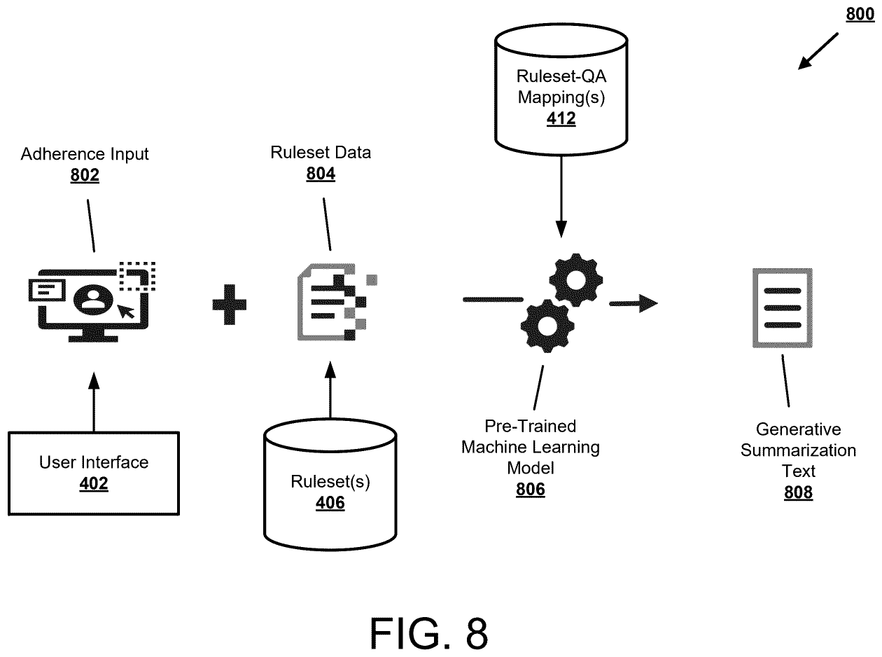

FIG. 8 depicts a dataflow diagram 800 of example hardware and/or software components for generating a response to a generative request in accordance with some embodiments of the present disclosure. As shown in the operational example 800, adherence input 802 and ruleset data 804 are provided as inputs (e.g., via second-stage prompt 414) to a pre-trained machine learning model 806 (e.g., of the one or more pre-trained machine learning models 410). The adherence input 802 is received via the user interface 402, for example, as part of and/or in the form of a generative request. The adherence input 802 may pertain to the ruleset data 804, which is retrieved from the database of one or more rulesets 406. Additionally, and/or alternatively, adherence input 802 may pertain to a ruleset-QA mapping, which is retrieved from the database of one or more ruleset-QA mappings 412.

As disclosed herewith, a second-stage prompt may be generated based on the adherence input 802, the ruleset data 804, and a ruleset-QA mapping. The second-stage prompt may be generated in accordance with a second tiered prompt structure that is specific to a generative output task to be performed by the pre-trained machine learning model 806. The generative output task may comprise a secondary task (e.g., second-stage) of a plurality of tasks. Accordingly, the second-stage prompt may be provided to the pre-trained machine learning model 806 such that the generative output task may be performed by the pre-trained machine learning model 806 to generate a generative summarization text 808 in response to the generative request. In this way, the pre-trained machine learning model 806 may be provided with a specific task focus that is based on outputs generated by independent tasks in a manner that guides the processing of the pre-trained machine learning model 806 to avoid performance deficiencies, such as hallucinations, and/or the like, that traditionally hinder the performance of machine learning models.

In some embodiments, generating the second-stage prompt comprises (i) storing, within memory (e.g., a compliance memory structure, database), the ruleset-QA mapping as one of a set of ruleset-QA mappings associated with the generative request, (ii) responsive to a determination that the adherence input comprises an unmet indicator, receiving the ruleset-QA mapping from the set of ruleset-QA mappings, (iii) determining the rule from the ruleset-QA mapping, and (iv) generating the second-stage prompt based on the rule. In some embodiments, the second-stage prompt comprises a second set of prompt instructions and a subset of ruleset that comprises the rule. In some embodiments, the generative request comprises an authorization identifier, a set of QA pairs, a set of adherence inputs respectively corresponding to the set of QA pairs, and a set of contextual attributes, and generating the second-stage prompt comprises (i) receiving the ruleset and a second-stage prompt template based on the authorization identifier, wherein the second-stage prompt template comprises the second set of prompt instructions and (ii) modifying the second-stage prompt template with a subset of the ruleset based on the set of adherence inputs and a set of ruleset-QA mappings respectively corresponding to the set of QA pairs. In some embodiments, the authorization identifier corresponds to a decision-specific user interface that comprises a set of interactive fields corresponding to the set of QA pairs.

In some embodiments, generative summarization text comprises human interpretable output that is generated by a language model. For example, generative summarization text may be representative of explanations and/or justifications for decisions made by and/or processed by a language model. In some embodiments, when a rule of a policy or procedure is not satisfied, a language model may be configured to use the rule's definition and context to generate summarization text that articulates why the rule was not met.

In some embodiments, an unmet indicator comprises a data element that is representative of ineligibility based on one or more rules that are associated with a policy or procedure. An unmet indicator may be provided in an adherence input and used to identify a QA pair that does not satisfy one or more rules of a ruleset associated with a policy or procedure. An unmet indicator may comprise a Boolean flag, an enumerated type, or a data structure suitable for representing a status code (e.g., “satisfied,” “not satisfied,” or “partially satisfied”). In some embodiments, summarization text representative of explanations and/or justifications is generated in response to an unmet indicator. In particular, when an unmet indicator is encountered, a prompt may be generated for instructing a language model to generate a detailed explanation of why a specific criterion associated with a rule was not satisfied. For example, in a healthcare context, if a clinical decision does not comply with an age restriction rule, an unmet indicator for an age criterion may trigger a generation of an explanation about an age requirement and/or how a patient's age does not meet the age requirement. As another example, in a computer security context, if a resource request does not comply with an access privilege rule, an unmet indicator for access privilege criterion may trigger a generation of an explanation about an access privilege requirement and/or how a user's access privilege does not meet the access privilege requirement.

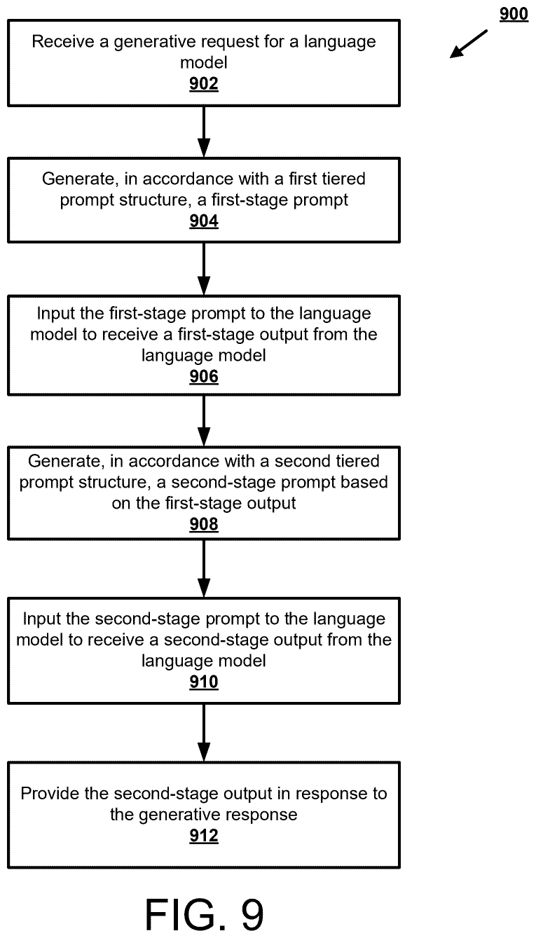

FIG. 9 depicts a flowchart diagram of an example multi-stage prompting process 900 in accordance with some embodiments of the present disclosure. The flowchart diagram depicts an example multi-stage prompting process that facilitates the performance of a series of tasks over multiple task stages in a manner that avoids performance deficiencies, such as hallucinations, and/or the like. The process 900 may be implemented by one or more computing devices, entities, and/or systems described herein. For example, via the various steps/operations of the process 900, the computing system 101 may generate a plurality of prompts according to a plurality of respectively corresponding prompt tier structures and provide the plurality of prompts to a language model at various task stages. By doing so, the process 900 improves computer functionality by improving a language model's ability to process complex, multi-faceted rules, and natural language inputs.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, receiving a generative request for a language model, wherein the generative request identifies a question-answer (QA) pair and an adherence input corresponding to the QA pair. For example, the computing system 101 may receive a generative request for a language model, wherein the generative request identifies a question-answer (QA) pair and an adherence input corresponding to the QA pair.

In some embodiments, the process 900 comprises, at operation 904, generating, in accordance with a first tiered prompt structure, a first-stage prompt that comprises the QA pair and a ruleset. For example, the computing system 101 may generate, in accordance with a first tiered prompt structure, a first-stage prompt that comprises the QA pair and a ruleset.

In some embodiments, the process 900 comprises, at operation 906, inputting the first-stage prompt to the language model to receive a first-stage output from the language model, wherein the first-stage output comprises a ruleset-QA mapping between the QA pair and a rule of the ruleset. For example, the computing system 101 may input the first-stage prompt to the language model to receive a first-stage output from the language model, wherein the first-stage output comprises a ruleset-QA mapping between the QA pair and a rule of the ruleset.

In some embodiments, the process 900 comprises, at operation 908, generating, in accordance with a second tiered prompt structure, a second-stage prompt based on the adherence input and comprising a mapped rule of the ruleset-QA mapping. For example, the computing system 101 may generate, in accordance with a second tiered prompt structure, a second-stage prompt based on the adherence input and comprising a mapped rule of the ruleset-QA mapping.

In some embodiments, the process 900 comprises, at operation 910, inputting the second-stage prompt to the language model to receive a second-stage output from the language model for the generative request. For example, the computing system 101 may input the second-stage prompt to the language model to receive a second-stage output from the language model for the generative request.

In some embodiments, the process 900 comprises, at operation 912, providing the second-stage output in response to the generative request. For example, the computing system 101 may provide the second-stage output in response to the generative request.

Some techniques of the present disclosure enable the generation of action outputs that may be performed to initiate one or more real world actions to achieve real-world effects. The techniques of the present disclosure may be used, applied, and/or otherwise leveraged to generate a diagnostic report, display/provide resources, generate, and/or execute action scripts, generate alerts or reminders, and/or generate one or more electronic communications. In some examples, the machine learning model outputs of the present disclosure may trigger action outputs (e.g., through control instructions) to automate computer performance actions and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

### Example 1

A computer-implemented method comprising: receiving, by one or more processors, a generative request for a language model, wherein the generative request identifies a question-answer (QA) pair and an adherence input corresponding to the QA pair; generating, by the one or more processors and in accordance with a first tiered prompt structure, a first-stage prompt that comprises the QA pair and a ruleset; inputting, by the one or more processors, the first-stage prompt to the language model to receive a first-stage output from the language model, wherein the first-stage output comprises a ruleset-QA mapping between the QA pair and a rule of the ruleset; generating, by the one or more processors and in accordance with a second tiered prompt structure, a second-stage prompt based on the adherence input and comprising the rule of the ruleset-QA mapping; inputting, by the one or more processors, the second-stage prompt to the language model to receive a second-stage output from the language model for the generative request; and providing, by the one or more processors, the second-stage output in response to the generative request.

### Example 2

The computer-implemented method of example 1, wherein generating the second-stage prompt comprises: storing, within a compliance memory structure, the ruleset-QA mapping as one of a set of ruleset-QA mappings associated with the generative request; responsive to a determination that the adherence input comprises an unmet indicator, receiving the ruleset-QA mapping from the set of ruleset-QA mappings; determining the rule from the ruleset-QA mapping; and generating the second-stage prompt based on the rule.

### Example 3

The computer-implemented method of example 1, wherein the QA pair comprises a question segment and an answer segment that correspond to a first interactive field within a user interface, and the second-stage output is configured to auto-populate a second interactive field within the user interface.

### Example 4

The computer-implemented method of example 1, wherein the first-stage prompt comprises the ruleset, a first set of prompt instructions, the QA pair, and a set of contextual attributes that are arranged in accordance with a first tiered prompt structure criterion.

### Example 5

The computer-implemented method of example 4, wherein the generative request comprises an authorization identifier, a set of QA pairs, a set of adherence inputs respectively corresponding to the set of QA pairs, and the set of contextual attributes, and generating the first-stage prompt comprises: receiving the ruleset and a first-stage prompt template based on the authorization identifier, wherein the first-stage prompt template comprises the first set of prompt instructions; and modifying the first-stage prompt template with the ruleset, the set of QA pairs, and the set of contextual attributes to generate the first-stage prompt.

### Example 6

The computer-implemented method of example 4, wherein (i) the generative request corresponds to a target entity associated with an entity profile and (ii) the set of contextual attributes comprises an attribute from the entity profile.

### Example 7

The computer-implemented method of example 1, wherein the second-stage prompt comprises a second set of prompt instructions and a subset of ruleset that comprises the rule.

### Example 8

The computer-implemented method of example 7, wherein the generative request comprises an authorization identifier, a set of QA pairs, a set of adherence inputs respectively corresponding to the set of QA pairs, and a set of contextual attributes, and generating the second-stage prompt comprises: receiving the ruleset and a second-stage prompt template based on the authorization identifier, wherein the second-stage prompt template comprises the second set of prompt instructions; and modifying the second-stage prompt template with a subset of the ruleset based on the set of adherence inputs and a set of ruleset-QA mappings respectively corresponding to the set of QA pairs.

### Example 9

The computer-implemented method of example 8, wherein the authorization identifier corresponds to a decision-specific user interface that comprises a set of interactive fields corresponding to the set of QA pairs.

### Example 10

The computer-implemented method of example 1, wherein the ruleset-QA mapping comprises a structured data object that identifies the rule, a question segment of the QA pair, and an explanatory output that is based on an answer segment of the QA pair and the rule.

### Example 11

A system comprising one or more processors and at least one memory storing processor-executable instructions that, when executed by any of the one or more processors, causes the one or more processors to perform operations comprising: receiving a generative request for a language model, wherein the generative request identifies a question-answer (QA) pair and an adherence input corresponding to the QA pair; generating, in accordance with a first tiered prompt structure, a first-stage prompt that comprises the QA pair and a ruleset; inputting the first-stage prompt to the language model to receive a first-stage output from the language model, wherein the first-stage output comprises a ruleset-QA mapping between the QA pair and a rule of the ruleset; generating, in accordance with a second tiered prompt structure, a second-stage prompt based on the adherence input and comprising the rule of the ruleset-QA mapping; inputting the second-stage prompt to the language model to receive a second-stage output from the language model for the generative request; and providing the second-stage output in response to the generative request.

### Example 12

The system of example 11, wherein to generate the second-stage prompt, the operations further comprise: storing, within a compliance memory structure, the ruleset-QA mapping as one of a set of ruleset-QA mappings associated with the generative request; responsive to a determination that the adherence input comprises an unmet indicator, receiving the ruleset-QA mapping from the set of ruleset-QA mappings; determining the rule from the ruleset-QA mapping; and generating the second-stage prompt based on the rule.

### Example 13

The system of example 11, wherein the QA pair comprises a question segment and an answer segment that correspond to a first interactive field within a user interface, and the second-stage output is configured to auto-populate a second interactive field within the user interface.

### Example 14

The system of example 11, wherein the first-stage prompt comprises the ruleset, a first set of prompt instructions, the QA pair, and a set of contextual attributes that are arranged in accordance with a first tiered prompt structure criterion.

### Example 15

The system of example 14, wherein the generative request comprises an authorization identifier, a set of QA pairs, a set of adherence inputs respectively corresponding to the set of QA pairs, and the set of contextual attributes, and to generate the first-stage prompt, the operations further comprise: receiving the ruleset and a first-stage prompt template based on the authorization identifier, wherein the first-stage prompt template comprises the first set of prompt instructions; and modifying the first-stage prompt template with the ruleset, the set of QA pairs, and the set of contextual attributes to generate the first-stage prompt.

### Example 16

The system of example 14, wherein (i) the generative request corresponds to a target entity associated with an entity profile and (ii) the set of contextual attributes comprises an attribute from the entity profile.

### Example 17

The system of example 14, wherein the second-stage prompt comprises a second set of prompt instructions and a subset of ruleset that comprises the rule.

### Example 18

The system of example 17, wherein the generative request comprises an authorization identifier, a set of QA pairs, a set of adherence inputs respectively corresponding to the set of QA pairs, and a set of contextual attributes, and to generate the second-stage prompt, the operations further comprise: receiving the ruleset and a second-stage prompt template based on the authorization identifier, wherein the second-stage prompt template comprises the second set of prompt instructions; and modifying the second-stage prompt template with a subset of the ruleset based on the set of adherence inputs and a set of ruleset-QA mappings respectively corresponding to the set of QA pairs.

### Example 19

The system of example 18, wherein the authorization identifier corresponds to a decision-specific user interface that comprises a set of interactive fields corresponding to the set of QA pairs.

### Example 20

One or more non-transitory computer-readable storage media including instructions that, when executed by one or more processors, cause the one or more processors to perform operations comprising: receiving a generative request for a language model, wherein the generative request identifies a question-answer (QA) pair and an adherence input corresponding to the QA pair; generating, in accordance with a first tiered prompt structure, a first-stage prompt that comprises the QA pair and a ruleset; inputting the first-stage prompt to the language model to receive a first-stage output from the language model, wherein the first-stage output comprises a ruleset-QA mapping between the QA pair and a rule of the ruleset; generating, in accordance with a second tiered prompt structure, a second-stage prompt based on the adherence input and comprising the rule of the ruleset-QA mapping; inputting the second-stage prompt to the language model to receive a second-stage output from the language model for the generative request; and providing the second-stage output in response to the generative request.

### Example 21

A computer-implemented method comprising: receiving, by one or more processors, a generative request for a first language model, wherein the generative request identifies a question-answer (QA) pair and an adherence input corresponding to the QA pair; generating, by the one or more processors and in accordance with a first tiered prompt structure, a first-stage prompt that comprises the QA pair and a ruleset; inputting, by the one or more processors, the first-stage prompt to the first language model to receive a first-stage output from the first language model, wherein the first-stage output comprises a ruleset-QA mapping between the QA pair and a rule of the ruleset; storing, by the one or more processors, the ruleset-QA mapping in memory; generating, by the one or more processors and in accordance with a second tiered prompt structure, a second-stage prompt based on the adherence input and comprising the rule of the ruleset-QA mapping stored in the memory; inputting, by the one or more processors, the second-stage prompt to a second language model to receive a second-stage output from the second language model for the generative request; and providing, by the one or more processors, the second-stage output in response to the generative request.

### Example 22

The computer-implemented method of example 21, wherein generating the second-stage prompt comprises: responsive to a determination that the adherence input comprises an unmet indicator, receiving the ruleset-QA mapping from the memory; determining the rule from the ruleset-QA mapping; and generating the second-stage prompt based on the rule.

### Example 23

The computer-implemented method of example 21, wherein the first language model and the second language model are the same.

### Example 24

The computer-implemented method of example 21, wherein the first language model and the second language model are different.

### Example 25

A system comprising one or more processors and at least one memory storing processor-executable instructions that, when executed by any of the one or more processors, causes the one or more processors to perform operations comprising: receiving a generative request for a first language model, wherein the generative request identifies a question-answer (QA) pair and an adherence input corresponding to the QA pair; generating, in accordance with a first tiered prompt structure, a first-stage prompt that comprises the QA pair and a ruleset; inputting the first-stage prompt to the first language model to receive a first-stage output from the first language model, wherein the first-stage output comprises a ruleset-QA mapping between the QA pair and a rule of the ruleset; storing the ruleset-QA mapping in memory; generating, in accordance with a second tiered prompt structure, a second-stage prompt based on the adherence input and comprising the rule of the ruleset-QA mapping stored in the memory; inputting the second-stage prompt to a second language model to receive a second-stage output from the second language model for the generative request; and providing the second-stage output in response to the generative request.

### Example 26

The system of example 25, wherein to generate the second-stage prompt, the operations further comprise: responsive to a determination that the adherence input comprises an unmet indicator, receiving the ruleset-QA mapping from the memory; determining the rule from the ruleset-QA mapping; and generating the second-stage prompt based on the rule.

### Example 27

The system of example 25, wherein the first language model and the second language model are the same.

### Example 28

The system of example 25, wherein the first language model and the second language model are different.

### Example 29

One or more non-transitory computer-readable storage media including instructions that, when executed by one or more processors, cause the one or more processors to perform operations comprising: receiving a generative request for a first language model, wherein the generative request identifies a question-answer (QA) pair and an adherence input corresponding to the QA pair; generating, in accordance with a first tiered prompt structure, a first-stage prompt that comprises the QA pair and a ruleset; inputting the first-stage prompt to the first language model to receive a first-stage output from the first language model, wherein the first-stage output comprises a ruleset-QA mapping between the QA pair and a rule of the ruleset; storing the ruleset-QA mapping in memory; generating, in accordance with a second tiered prompt structure, a second-stage prompt based on the adherence input and comprising the rule of the ruleset-QA mapping stored in the memory; inputting the second-stage prompt to a second language model to receive a second-stage output from the second language model for the generative request; and providing the second-stage output in response to the generative request.

### Example 30

The one or more non-transitory computer-readable storage media of example 29, wherein to generate the second-stage prompt, the operations further comprise: responsive to a determination that the adherence input comprises an unmet indicator, receiving the ruleset-QA mapping from the memory; determining the rule from the ruleset-QA mapping; and generating the second-stage prompt based on the rule.

### Example 31

The one or more non-transitory computer-readable storage media of example 29, wherein the first language model and the second language model are the same.

### Example 32

The one or more non-transitory computer-readable storage media of example 29, wherein the first language model and the second language model are different.

### Example 33

The computer-implemented method of example 1, wherein the method further comprises training the language model.

### Example 34

The computer-implemented method of example 21, wherein the method further comprises training the first language model or the second language model.

### Example 35

The computer-implemented method of examples 33 or 34, wherein the training is performed by the one or more processors.

### Example 36

The computer-implemented method of example 35, wherein the one or more processors are comprised in a first computing entity; and the training is performed by one or more other processors comprised in a second computing entity.

### Example 37

The system of example 11, wherein the operations further comprise training the language model.

### Example 38

The system of example 25, wherein the operations further comprise training the first language model or the second language model.

### Example 39

The system of example 37, wherein the one or more processors are comprised in a first computing entity; and the language model is trained by one or more other processors comprised in a second computing entity.

### Example 40

The system of example 38, wherein the one or more processors are comprised in a first computing entity; and the first language model or the second language model are trained by one or more other processors comprised in a second computing entity.

### Example 41

The one or more non-transitory computer-readable storage media of example 20, wherein the operations further comprise training the language model.

### Example 42

The one or more non-transitory computer-readable storage media of example 29, wherein the operations further comprise training the first language model or the second language model.

### Example 43

The one or more non-transitory computer-readable storage media of example 41, wherein the one or more processors are comprised in a first computing entity; and the language model is trained by one or more other processors comprised in a second computing entity.

### Example 44

The one or more non-transitory computer-readable storage media of example 42. wherein the one or more processors are comprised in a first computing entity; and the first language model or the second language model are trained by one or more other processors comprised in a second computing entity.

1. A computer-implemented method comprising:
receiving, by one or more processors, a generative request for a first language model, wherein the generative request identifies a question-answer (QA) pair and an adherence input corresponding to the QA pair;
generating, by the one or more processors and in accordance with a first tiered prompt structure, a first-stage prompt that comprises the QA pair and a ruleset;
inputting, by the one or more processors, the first-stage prompt to the first language model to receive a first-stage output from the first language model, wherein the first-stage output comprises a ruleset-QA mapping between the QA pair and a rule of the ruleset;
storing, by the one or more processors, the ruleset-QA mapping in memory;
generating, by the one or more processors and in accordance with a second tiered prompt structure, a second-stage prompt based on the adherence input and comprising the rule of the ruleset-QA mapping stored in the memory;
inputting, by the one or more processors, the second-stage prompt to a second language model to receive a second-stage output from the second language model for the generative request; and
providing, by the one or more processors, the second-stage output in response to the generative request.

2. The computer-implemented method of claim 1, wherein generating the second-stage prompt comprises:
responsive to a determination that the adherence input comprises an unmet indicator, receiving the ruleset-QA mapping from the memory;
determining the rule from the ruleset-QA mapping; and
generating the second-stage prompt based on the rule.

3. The computer-implemented method of claim 1, wherein the QA pair comprises a question segment and an answer segment that correspond to a first interactive field within a user interface, and the second-stage output is configured to auto-populate a second interactive field within the user interface.

4. The computer-implemented method of claim 1, wherein the first-stage prompt comprises the ruleset, a first set of prompt instructions, the QA pair, and a set of contextual attributes that are arranged in accordance with a first tiered prompt structure criterion.

5. The computer-implemented method of claim 4, wherein the generative request comprises an authorization identifier, a set of QA pairs, a set of adherence inputs respectively corresponding to the set of QA pairs, and the set of contextual attributes, and generating the first-stage prompt comprises:
receiving the ruleset and a first-stage prompt template based on the authorization identifier, wherein the first-stage prompt template comprises the first set of prompt instructions; and
modifying the first-stage prompt template with the ruleset, the set of QA pairs, and the set of contextual attributes to generate the first-stage prompt.

6. The computer-implemented method of claim 4, wherein (i) the generative request corresponds to a target entity associated with an entity profile and (ii) the set of contextual attributes comprises an attribute from the entity profile.

7. The computer-implemented method of claim 1, wherein the second-stage prompt comprises a second set of prompt instructions and a subset of ruleset that comprises the rule.

8. The computer-implemented method of claim 7, wherein the generative request comprises an authorization identifier, a set of QA pairs, a set of adherence inputs respectively corresponding to the set of QA pairs, and a set of contextual attributes, and generating the second-stage prompt comprises:
receiving the ruleset and a second-stage prompt template based on the authorization identifier, wherein the second-stage prompt template comprises the second set of prompt instructions; and
modifying the second-stage prompt template with a subset of the ruleset based on the set of adherence inputs and a set of ruleset-QA mappings respectively corresponding to the set of QA pairs.

9. The computer-implemented method of claim 1, wherein the first language model and the second language model are the same.

10. The computer-implemented method of claim 1, wherein the first language model and the second language model are different.

11. A system comprising
one or more processors and
at least one memory storing processor-executable instructions that, when executed by any of the one or more processors, causes the one or more processors to perform operations comprising:
receiving a generative request for a first language model, wherein the generative request identifies a question-answer (QA) pair and an adherence input corresponding to the QA pair;
generating, in accordance with a first tiered prompt structure, a first-stage prompt that comprises the QA pair and a ruleset;
inputting the first-stage prompt to the first language model to receive a first-stage output from the first language model, wherein the first-stage output comprises a ruleset-QA mapping between the QA pair and a rule of the ruleset;
storing the ruleset-QA mapping in memory;
generating, in accordance with a second tiered prompt structure, a second-stage prompt based on the adherence input and comprising the rule of the ruleset-QA mapping stored in the memory;
inputting the second-stage prompt to a second language model to receive a second-stage output from the second language model for the generative request; and
providing the second-stage output in response to the generative request.

12. The system of claim 11, wherein to generate the second-stage prompt, the operations further comprise:
responsive to a determination that the adherence input comprises an unmet indicator, receiving the ruleset-QA mapping from the memory;
determining the rule from the ruleset-QA mapping; and
generating the second-stage prompt based on the rule.

13. The system of claim 11, wherein the QA pair comprises a question segment and an answer segment that correspond to a first interactive field within a user interface, and the second-stage output is configured to auto-populate a second interactive field within the user interface.

14. The system of claim 11, wherein the first-stage prompt comprises the ruleset, a first set of prompt instructions, the QA pair, and a set of contextual attributes that are arranged in accordance with a first tiered prompt structure criterion.

15. The system of claim 14, wherein the generative request comprises an authorization identifier, a set of QA pairs, a set of adherence inputs respectively corresponding to the set of QA pairs, and the set of contextual attributes, and to generate the first-stage prompt, the operations further comprise:
receiving the ruleset and a first-stage prompt template based on the authorization identifier, wherein the first-stage prompt template comprises the first set of prompt instructions; and
modifying the first-stage prompt template with the ruleset, the set of QA pairs, and the set of contextual attributes to generate the first-stage prompt.

16. The system of claim 14, wherein (i) the generative request corresponds to a target entity associated with an entity profile and (ii) the set of contextual attributes comprises an attribute from the entity profile.

17. The system of claim 14, wherein the second-stage prompt comprises a second set of prompt instructions and a subset of ruleset that comprises the rule.

18. The system of claim 17, wherein the generative request comprises an authorization identifier, a set of QA pairs, a set of adherence inputs respectively corresponding to the set of QA pairs, and a set of contextual attributes, and to generate the second-stage prompt, the operations further comprise:
receiving the ruleset and a second-stage prompt template based on the authorization identifier, wherein the second-stage prompt template comprises the second set of prompt instructions; and
modifying the second-stage prompt template with a subset of the ruleset based on the set of adherence inputs and a set of ruleset-QA mappings respectively corresponding to the set of QA pairs.

19. The system of claim 11, wherein the first language model and the second language model are the same.

20. One or more non-transitory computer-readable storage media including instructions that, when executed by one or more processors, cause the one or more processors to perform operations comprising:
receiving a generative request for a first language model, wherein the generative request identifies a question-answer (QA) pair and an adherence input corresponding to the QA pair;
generating, in accordance with a first tiered prompt structure, a first-stage prompt that comprises the QA pair and a ruleset;
inputting the first-stage prompt to the first language model to receive a first-stage output from the first language model, wherein the first-stage output comprises a ruleset-QA mapping between the QA pair and a rule of the ruleset;
storing the ruleset-QA mapping in memory;
generating, in accordance with a second tiered prompt structure, a second-stage prompt based on the adherence input and comprising the rule of the ruleset-QA mapping stored in the memory;
inputting the second-stage prompt to a second language model to receive a second-stage output from the second language model for the generative request; and
providing the second-stage output in response to the generative request.
